(19) United States
(12) Patent Application Publication
(10) Pub. No.: US 2010/0253237 A1
(43) Pub. Date: Oct. 7, 2010

(54) OPTIMIZED APPLICATOR STRUCTURES FOR HOMOGENEOUS DISTRIBUTION OF ELECTRO-MAGNETIC FIELDS IN GAS DISCHARGE LAMPS

(75) Inventors: Michael Meisser, Karlsruhe (DE); Rainer Kling, Dossenheim (DE); Klaus Stockwald, Germering (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/749,564

(22) Filed: Mar. 30, 2010

Related U.S. Application Data
(60) Provisional application No. 61/165,737, filed on Apr. 1, 2009.

(51) Int. Cl. H05B 41/24

(52) U.S. Cl. 315/248

(57) ABSTRACT

Various embodiments provide an electrodeless high intensity discharge lamp (EHID), including: a bulb containing a fill mixture for generating a light emission when excited by microwave energy; and at least two applicator arms for coupling the microwave energy to the fill mixture, the at least two applicator arms being separated by at least one delay line, the at least one delay line introducing a delay of λ/4, wherein λ is the wavelength of the microwave energy, wherein each of the at least two applicator aims are coupled to each other via an open loop structure.

### CROSS-REFERENCE TO RELATED APPLICATION

This application claims the benefit of U.S. patent application Ser. No. 61/165,737, which was filed Apr. 1, 2009, and is incorporated herein by reference in its entirety.

### TECHNICAL FIELD

Various embodiments relate to the field of electrodeless high pressure discharge lamps (EHID), e.g. intended for general illumination or photo-optical application. By way of example, it refers to optimized applicator structures for Homogeneous Distribution of Electro-Magnetic Fields in such Gas Discharge Lamps.

### BACKGROUND

From US-A 2009146543 plasma lamps are known. They are based on electrodeless high pressure discharge lamps which are often referred to as EHID. This citation is incorporated by reference.

Further References which deal with plasma lamps of this kind are:

Koch, B. (2002). Experimental examinations on new compact microwave resonators for electrodeless excitation of high-pressure discharge lamps. Light technical institute. Karlsruhe, University Karlsruhe; Dissertation [Experimentelle Untersuchungen an neuartigen kompakten Mikrowellenresonatoren zur elektrodenlosen Anregung von Hochdruckentladungslampen. Lichttechnisches Institut. Karlsruhe, Universität Karlsruhe; Dissertation.]

A device for plasma excitation by means of microwaves is disclosed as DE-A 103 35 523.

Details for Electrodeless HID Lamp with Microwave Power Coupler are published under CA-A 2 042 258 and CA-A 2 042 251.

### SUMMARY

Various embodiments provide an electrodeless high intensity discharge lamp (EHID), including: a bulb containing a fill mixture for generating a light emission when excited by microwave energy; and at least two applicator arms for coupling the microwave energy to the fill mixture, the at least two applicator arms being separated by at least one delay line, the at least one delay line introducing a delay of λ/4, wherein λ is the wavelength of the microwave energy, wherein each of the at least two applicator arms are coupled to each other via an open loop structure.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a development of four arm applicator structures;

FIG. 2 shows possible field modes using such applicator structures;

FIG. 3 shows delay line structure in accordance with a first embodiment;

FIG. 4 shows symmetric delay line structures;

FIG. 5 shows use of power dividers;

FIG. 6 shows an open delay circle;

FIG. 7 shows the use of at least four applicator arms; and

FIG. 8 shows a pill shape of the lamp.

DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various embodiments provide an improved EHID lamp.

Various embodiments may provide one or more of the following features:

1. Setting the delay between the applicator arms at λ/4 and use of an open loop delay line (open rat race circle) allows a more homogeneous field distribution through generation of various field modes.

2. Dynamically changeable phase of multiple power inputs to the applicator arms allows field rotation and thus a homogeneous field distribution. Furthermore, the stimulation of specific acoustic modes in the volume of medium inside the lamp is possible.

3. Uniform power distribution to all applicator arms through the use of power dividers. Realization of the power dividers, for example, in strip line or microstrip technology.

4. Coupling of microwave energy at a knot point of the applicator structure to allow a symmetric delay distribution.

5. Arrangement of the applicator arms in space to improve the homogeneity of the field distribution in a spherical lamp volume, leading to a better usage of the gas volume for light generation.

6. Increase of the field homogeneity of the electric field inside the lamp for applicator arm arrangements in one geometric plane through the use of a pill or cushion shape of the lamp body. The gas is concentrated in the geometric plane of the applicators, enabling higher utilization of the gas volume for light production.

7. An electrodeless high pressure discharge lamp including:

(a) a waveguide having a body of a preselected shape and dimensions, the body including at least one dielectric material and having at least one surface determined by a waveguide outer surface, each said material having a dielectric constant greater than approximately 2;

(b) a first microwave probe positioned within and in intimate contact with the body, adapted to couple microwave energy into the body from a microwave source having an output and an input and operating within a frequency range from about 0.25 GHz to about 30 GHz at a preselected frequency and intensity, the probe connected to the source output, said frequency and intensity and said body shape and dimensions selected so that the body resonates in at least one resonant mode having at least one electric field maximum;

(c) the body having a lamp chamber depending from said waveguide outer surface and determined by a chamber aperture and a chamber enclosure determined by a bottom surface and at least one surrounding wall surface;

(d) a transparent, dielectric bulb within the lamp chamber; and

(e) a fill mixture contained within the bulb which when receiving microwave energy from the resonating body forms a light-emitting plasma.

Various embodiments provide a highly efficient coupling of electrical energy with high energy density, especially in the microwave range, in the volume of an electrodeless high intensity discharge (EHID) lamp. Such a lamp can be used with fluid, solid or gaseous media for light generation.

In addition, a highly homogeneous field distribution in the lamp volume (plasma space) is provided to fully exploit this volume for light generation. The electric power distributed from each applicator must have the same value in order to allow symmetric field distribution.

Particularly for HID lamps, high energy density inside the lamp volume is important. Due to the small dimensions of the lamp, applicator structures must be compact, which naturally excludes cavity resonators at operation frequencies in the lower GHz range. Moreover, applicator structures should shade the lamp as little as possible in order to minimize optical losses.

The application of microwave power in HID lamps is currently done by the use of cavity resonators or two opposite applicators. A characteristic applicator structure with one delay line and two filed applicators with coupling chokes is shown in CA-A 2 042 258 and CA-A 2 042 251.

In (Koch 2002) and DE-A 103 35 523 are applicator structures shown which contain four applicator arms, located in the same geometric plane.

The disadvantages of these proposed structures are:

(1) unsymmetrical power distribution,

(2) suboptimal phase shift between applicator arms, and

(3) low field homogeneity due to low variance of electric potential between the applicator arms.

By the use of applicator structures with more than two applicator arms in the geometric plane or in space, the field distribution can be homogenized. A pill or pillow shape of the lamp improves the field distribution for applicator structures allocated in one geometric plane. Arrangement of the applicators in the geometric plane is advantageous to provide homogeneous field distribution within a spherical bulb.

A dynamic field rotation is generated by the use of different power sources coupling energy into the lamp with variable phase shift. The same average power distribution to each applicator arm (power sharing) is provided by the use of power dividers.

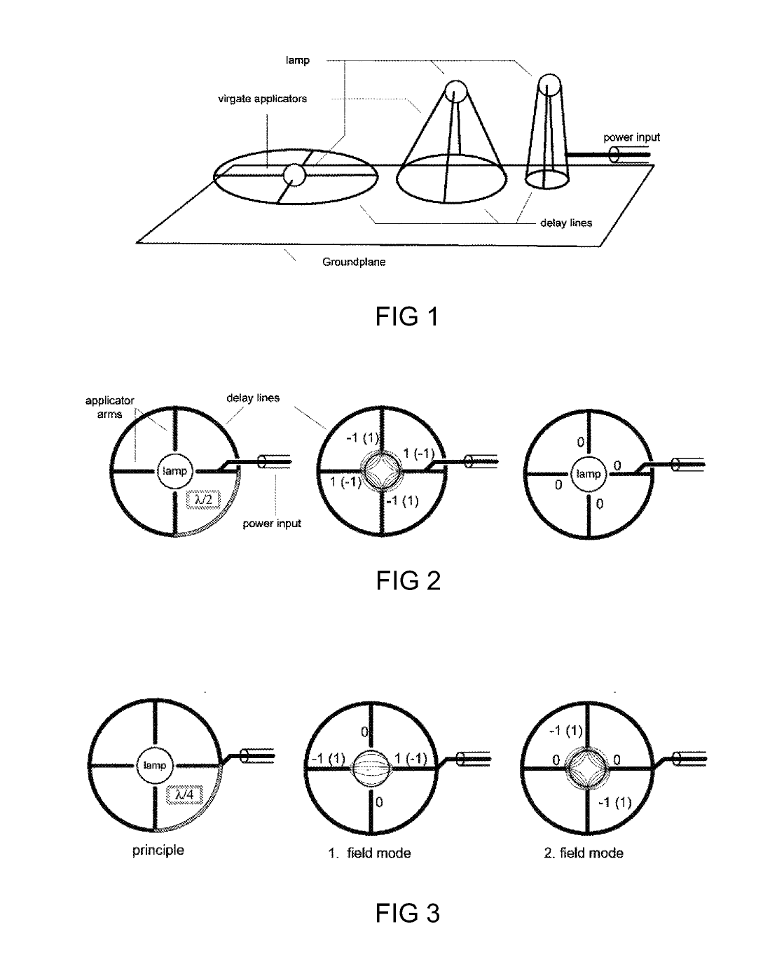

FIG. 1 shows an applicator structure with applicators and delay lines in air referring back to (Koch 2002) and DE-A 103 35 523. A four-arm applicator structure from given Magnetron structure was developed. Note that the power input is situated at one arm and not at a knot point. This leads to asymmetric time delay between the applicator arms.

FIG. 2 shows possible field modes using applicator structures referring back to (Koch 2002) and DE-A 103 35 523. Note the phase delay of λ/2 between the applicator arms. The numbers mark the polarities of the voltage at the respective applicator arm. The delay lines are developed in a ring style and use air as dielectric. Especially in the figure shown on the right in FIG. 1, power input is not situated at the knot point but at one applicator arm. This leads to asymmetric time delay between the applicator arms and therefore to sub-optimal electric field strengths. Furthermore, the power is distributed to the different arms in a non-uniform way.

FIG. 3 shows that the use of a delay of λ/4 allows two field modes to occur. The power input is located at a knot point. The closed delay line ring (rat-race cycle) has the disadvantage that the upper and the lower applicator arm will always have the same potential due to the same time delay. Therefore, there is no electric field between these applicators.

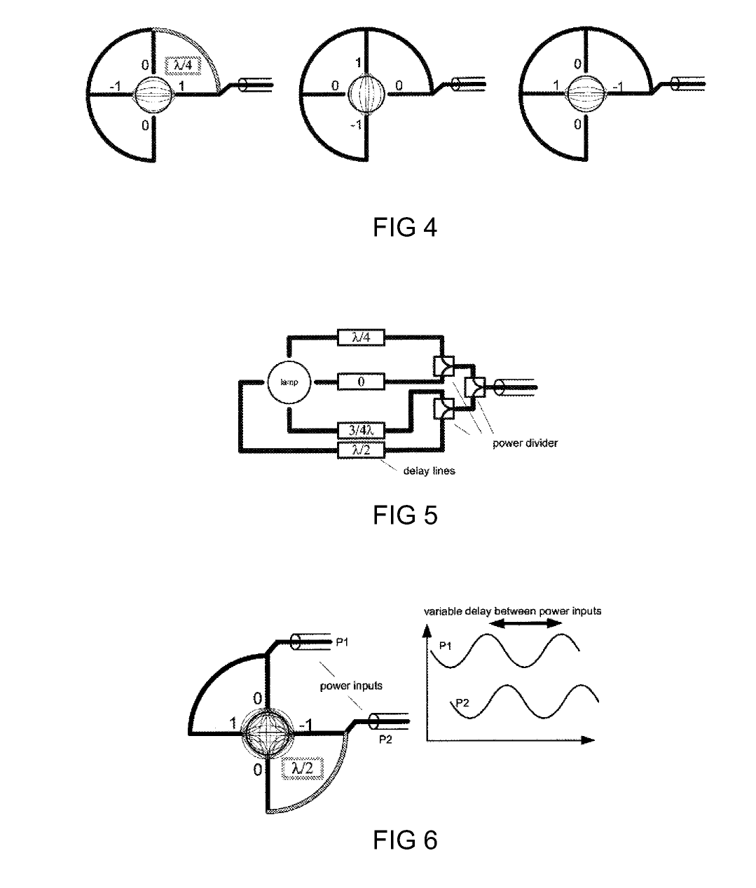

FIG. 4 shows that a λ/4 symmetric delay line structure with open ring allows the development of a rotating field inside the lamp volume. The maxima of the electric field always occur at opposite applicator arms leading to an efficient field distribution inside the lamp.

FIG. 5 shows that the power must be divided by a power divider in order to achieve an even power distribution in all applicator arms. According to various embodiments this will be done by the use of power dividers set up using strip line or Microstrip techniques. The delay lines are located between the respective power splitter and an applicator arm providing sufficient λ/4 delay between the applicators.

FIG. 6 shows that an open delay circle can further be utilized by the use of multiple power inputs in order to allow a dynamic variation of the phase delay between the power inputs. This brings along additional homogeneity and the possibility to excite acoustic resonances within the lamp volume (center) if the dynamic phase shift is done with sufficient low frequency.

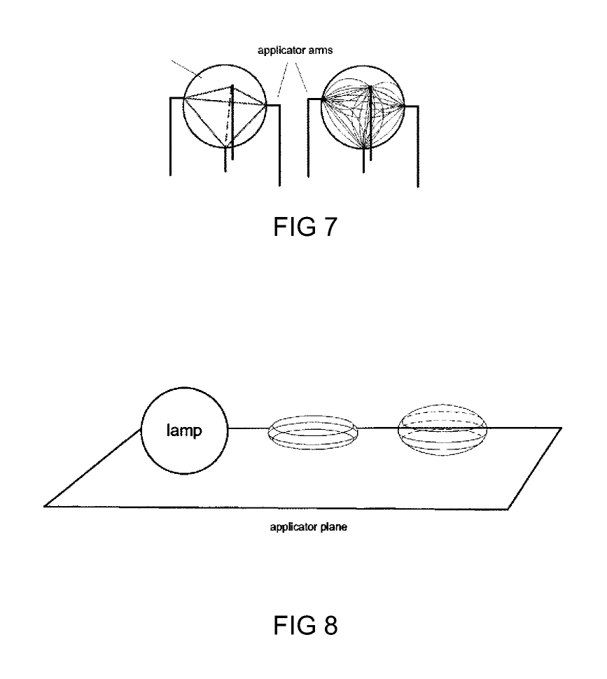

FIG. 7 shows that through the use of at least four applicator arms in space a more homogeneous field distribution can be achieved for spherical or sphere-like lamp body shapes (central sphere).

FIG. 8 shows that if the applicator arms are only located in one geometric applicator plane, the lamp shape should be adapted to allow more homogeneous field distribution, see the right embodiments. In various embodiments, such a pillow shape or pill shape of the lamp vessel is used e.g. with the greatest lamp diameter or lamp axis located in the applicator plane.

The EHID lamp may include one or more of the following features:

(a) a waveguide having a body of a preselected shape and dimensions, the body including at least one dielectric material and having at least one surface determined by a waveguide outer surface, each said material having a dielectric constant greater than approximately 2;

(b) a first microwave probe positioned within and in intimate contact with the body, adapted to couple microwave energy into the body from a microwave source having an output and an input and operating within a frequency range from about 0.25 GHz to about 30 GHz at a preselected frequency and intensity, the probe connected to the source output, said frequency and intensity and said body shape and dimensions selected so that the body resonates in at least one resonant mode having at least one electric field maximum;

(c) the body having a lamp chamber depending from said waveguide outer surface and determined by a chamber aperture and a chamber enclosure determined by a bottom surface and at least one surrounding wall surface;

(d) a transparent, dielectric bulb within the lamp chamber; and

(e) a fill mixture contained within the bulb which when receiving microwave energy from the resonating body forms a light-emitting plasma.

More generally a plasma lamp is disclosed including a fill of fill mixture contained within a bulb which when receiving microwave energy from a resonating body forms a light-emitting plasma wherein the fill may include organic compounds chosen from a group which includes acetylene, methane, propane, butane, and acetylides.

1. Setting the delay between the applicator arms at λ/4 and use of an open loop delay line (open rat race circle) allows a more homogeneous field distribution through generation of various field modes.

2. Dynamically changeable phase of multiple power inputs to the applicator arms allows field rotation and thus a homogeneous field distribution. Furthermore, the stimulation of specific acoustic modes in the volume of medium inside the lamp is possible.

3. Uniform power distribution to all applicator arms through the use of power dividers. Realization of the power dividers, for example, in strip line or microstrip technology.

4. Coupling of microwave energy at a knot point of the applicator structure to allow a symmetric delay distribution.

5. Arrangement of the applicator arms in space to improve the homogeneity of the field distribution in a spherical lamp volume, leading to a better usage of the gas volume for light generation.

6. Increase of the field homogeneity of the electric field inside the lamp for applicator arm arrangements in one geometric plane through the use of a pill or cushion shape of the lamp body. The gas is concentrated in the geometric plane of the applicators, enabling higher utilization of the gas volume for light production.

7. An electrodeless high pressure discharge lamp with applicator structure and delay line including:

(a) a waveguide having a body of a preselected shape and dimensions, the body including at least one dielectric material and having at least one surface determined by a waveguide outer surface, each said material having a dielectric constant greater than approximately 2;

(b) a first microwave probe positioned within and in intimate contact with the body, adapted to couple microwave energy into the body from a microwave source having an output and an input and operating within a frequency range from about 0.25 GHz to about 30 GHz at a preselected frequency and intensity, the probe connected to the source output, said frequency and intensity and said body shape and dimensions selected so that the body resonates in at least one resonant mode having at least one electric field maximum;

(c) the body having a lamp chamber depending from said waveguide outer surface and determined by a chamber aperture and a chamber enclosure determined by a bottom surface and at least one surrounding wall surface;

(d) a transparent, dielectric bulb within the lamp chamber; and

(e) a fill mixture contained within the bulb which when receiving microwave energy from the resonating body forms a light-emitting plasma.

Various embodiments may provide optimized applicator structures for Homogeneous Distribution of Electro-Magnetic Fields in Gas Discharge Lamps.

Various embodiments may provide a setting of the delay between the applicator arms at λ/4 and the use of an open loop delay line (open rat race circle) which allows a more homogeneous field distribution through generation of various field modes.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An electrodeless high intensity discharge lamp (EHID), comprising:
a bulb containing a fill mixture for generating a light emission when excited by microwave energy; and
at least two applicator arms for coupling the microwave energy to the fill mixture, the at least two applicator aims being separated by at least one delay line, the at least one delay line introducing a delay of λ/4, wherein λ is the wavelength of the microwave energy, wherein each of the at least two applicator arms are coupled to each other via an open loop structure.

2. The electrodeless high intensity discharge lamp according to claim 1, wherein the phase of the microwave energy delivered by each of the at least two applicator arms is changeable to cause field rotation within the bulb.

3. The electrodeless high intensity discharge lamp according to claim 1, wherein each of the at least two applicator arms comprises a proximal end coupled to the bulb and a distal end, the distal end of each of at least two applicator aims being coupled to the open loop structure.

4. The electrodeless high intensity discharge lamp according to claim 3, wherein each of the at least two applicator arms comprises a virgate applicator arm.

5. The electrodeless high intensity discharge lamp according to claim 3, wherein the lamp further comprises at least one microwave probe for coupling the open loop structure to a microwave source, the at least one microwave probe being coupled to the open loop structure at a node at which one of the at least two applicator arms is coupled to the open loop structure.

6. The electrodeless high intensity discharge lamp according to claim 1, wherein the lamp further comprises a power divider for dividing the microwave input power substantially uniformly between the at least two applicator arms.

7. The electrodeless high intensity discharge lamp according to claim 6, wherein the power divider comprises a strip line or microstrip power divider.

8. The electrodeless high intensity discharge lamp according to claim 1, wherein the at least two applicator arms are arranged equidistant about the bulb.

9. The electrodeless high intensity discharge lamp according to claim 1, wherein the lamp comprises four applicator arms and the bulb is substantially spherical in shape.

10. The electrodeless high intensity discharge lamp according to claim 1, wherein the at least two applicator arms are located in a single plane.

11. The electrodeless high intensity discharge lamp according to claim 10, wherein the bulb is substantially pill or pillow shaped and wherein the greater diameter of the bulb is located in the plane of the at least two applicator arms.

12. The electrodeless high intensity discharge lamp according to claim 1, wherein the fill mixture comprises organic compounds containing at least one of acetylene, methane, propane, butane and acetylides.
